(19) United States
(12) Patent Application Publication
(10) Pub. No.: US 2003/0105972 A1
(43) Pub. Date: Jun. 5, 2003

(54) Method for data security with lock in a hard disk and a solid state disk

(75) Inventor: Wei Kuang Teng, Taipei (TW)

Correspondence Address: BRUCE H. TROXELL, SUITE 1404, 5205 LEESBURG PIKE, FALLS CHURCH, VA, 22041, US

(73) Assignee: POWER QUOTIENT INTERNATIONAL CO., LTD.

(21) Appl. No.: 10/035,315

(22) Filed: Jan. 4, 2002

(30) Foreign Application Priority Data
Nov. 28, 2001 (CN) 01139724.1

(51) Int. Cl. G06F 12/14

(52) U.S. Cl. 713/200

(57) ABSTRACT

A method for data security with lock in a hard disk and a solid state disk is provided. The method makes a frequently used system record possible to be saved in the user zone. The main system program or the drive program can be saved in the ROM zone to avoid that the programs are subjected to an abnormal change or a not allowed change and revision so as not to damage the operation of the system. The core program of the system can be saved in the protect zone and the password has to be confirmed before the core program can be executed. Therefore, the present invention can give the disk system an effective function of protect with lock to protect the intellectual property for the system designer and to protect the data in secret and with safety for the user.

### BACKGROUND OF THE INVENTION

1. Field of The Invention

The present invention relates to a method for data security with lock in a hard disk and a solid state disk, and, particularly, to a new, practical and convenient method, which can enhance the security of data in a disk.

2. Description of Related Art

Currently, for a hard disk (HD) or a solid state disk (SSD), the security of the inner data thereof is getting important due to the popularity of home information electrical appliances. Accordingly, how to secure the data in a disk is an important subject from the standpoint of protection of the intellectual property with regard to the saved programs created by the system designer or the data maintenance for the system user. At the present, each partitioned zone provides the same function after the disk is divided into several zones, that is, each of the partitioned zones can be read and written such that it is not possible for partitioned zones to be made a distinction between them and identify which zone is a read and write zone, which zone is ROM zone, and which zone is a protect zone against read and write. Therefore, it is unable to satisfy the demand with regard to the secure maintenance of disk data for the user.

### SUMMARY OF THE INVENTION

Accordingly, an object of the present invention is to provide a method for data security with lock in a hard disk and a solid state disk, which makes a frequently used system record possible to be saved in a user zone. The main system program or the drive program can be saved in a ROM zone to avoid that the programs are subjected to an abnormal change or a not allowed change and revision so as not to damage the operation of the system. A core program of the system can be saved in a protect zone and the password has to be confirmed before the core program can be executed. Therefore, the present invention can offer the disk system an effective protection with lock so as to protect the intellectual property of the system designer and the secret data of the user reliably. Therefore, the function provided in the present invention is not possible to be performed by the conventional various types of disk drivers.

The present invention provides a method for data security with lock in a hard disk and a solid state disk, and the method comprises following steps: a procedure for partitioning a disk drive into a plurality of disk zones;

offering a plurality of registers for indicating a record of a size of the respective partitioned disk zone; and offering a procedure of mathematical operation for treating a user input data and a register data.

In order to achieve the preceding object, a register R_index, a register P_index and a register LBA_max are used for indicating records of three partitioned zone sizes. When the register R_index≧1 and the register LBA_max>the register P_index>the register R_index, the disk drive is divided into three zones, the disk drive is divided into the user zone, the ROM zone and the protect zone. When the register R_index≧1 and the register LBA_max=the register P_index>the register R_index, the disk drive is divided into two zones, the user zone and the ROM zone. When the register R_index≧1 and the register LBA_maxthe>the register P_index=the register R_index, the disk drive is divided into two zones, the user zone and the protect zone. When the register R_index≧1 and the register LBA_max=the register P_index=the register R_index, the disk drive is divided into the user zone.

### BRIEF DESCRIPTION OF THE DRAWINGS

The present invention can be more fully understood by reference to the following description and accompanying drawings, in which:

FIG. 1 is a flow chart illustrating the process performed in a preferred embodiment of the present invention;

FIG. 2 is a table illustrating disk commands corresponding to actions of each partitioned zone under a lock mode in the preferred embodiment;

FIG. 3 is a schematic diagram illustrating a disk in a state of being divided;

FIG. 4 is a plan view illustrating a structure of various registers;

FIG. 5 is a flow chart of setting up a vender code and a vender lock in the preferred embodiment of the present invention;

FIG. 6 is a schematic diagram illustrating an operation mode of firmware in the preferred embodiment during treating a password; and

FIG. 7 is a flow chart for deleting function of the ROM zone and the protect zone in the preferred embodiment.

### DETAILED DESCRIPTION OF THE PREFERRED EMBODIMENTS

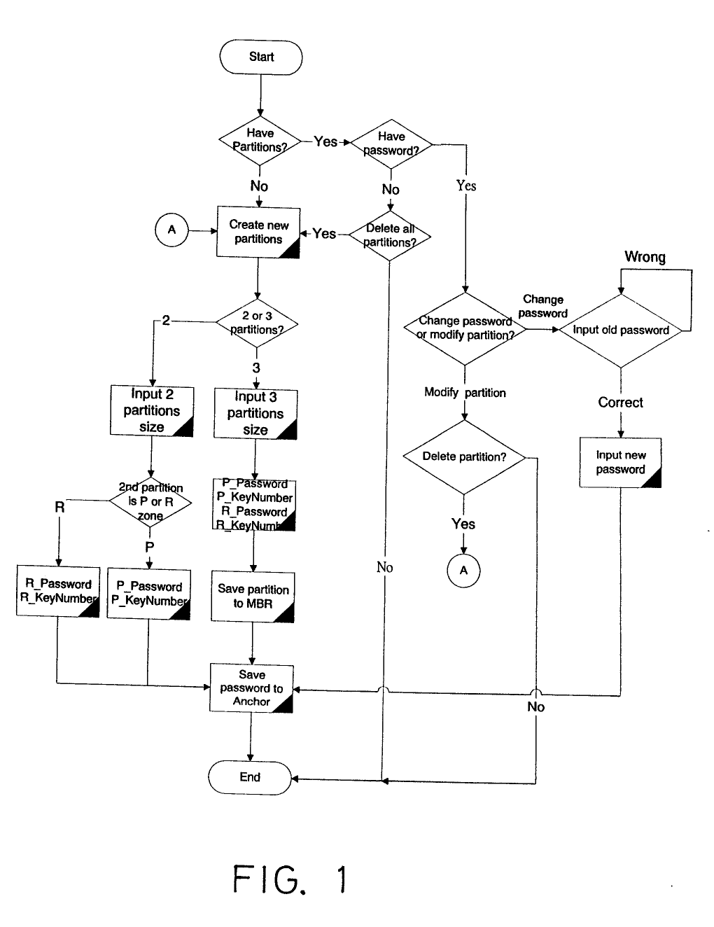

Referring to FIG. 1, a flow chart of processing a method for data security with lock in a hard disk and a solid state disk according to the present invention is illustrated. First of all, the disk drive 1 is divided into several zones by way of disk partition, and, for instance, the disk drive 1 is divided into two or three logic disks and the logic disks are given a zone definition with a read or write restriction for performing specific functions.

Hence, the present invention defines three zone names, i.e., a ROM zone 11, a protect zone 12 and a user zone 13. Thus, the disk drive 1 can be divided with a partition way of four different arrangements, which are listed hereinafter:

(1) the user zone 13, the ROM zone 11 and the protect zone 12.

(2) the user zone 13 and the ROM zone 11.

(3) the user zone 13 and the protect zone 12.

(4) the user zone 13.

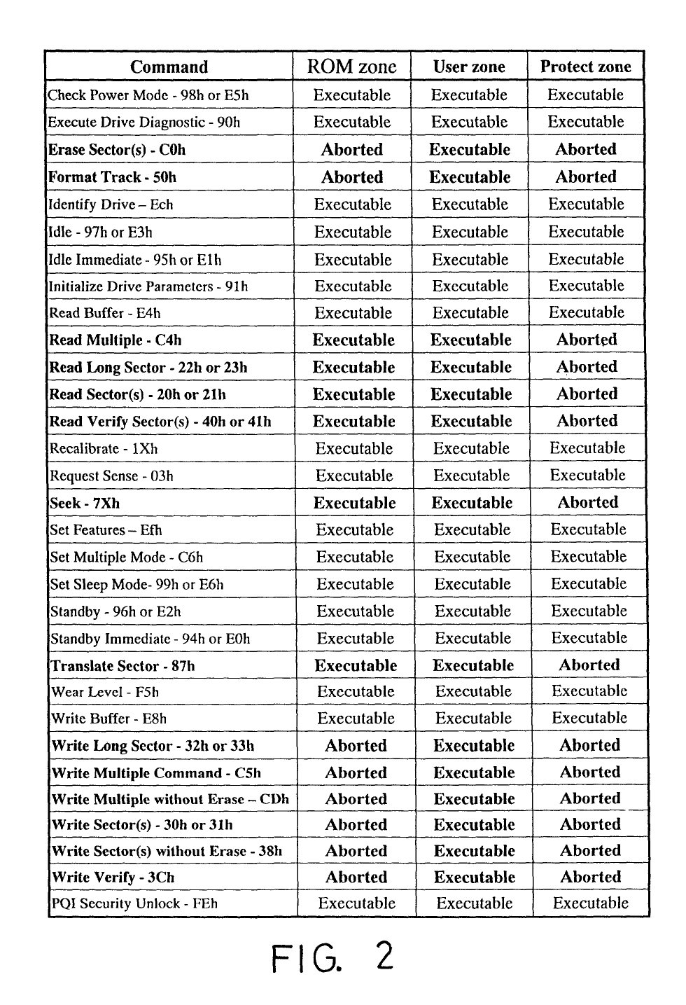

The user zone 13 can execute all the ATA commands as the ordinary disk drive does, but the ROM zone 11 can read data only so that data erase or data write is prohibited in the ROM zone 11. The protect zone 12 executes any command related to operating the sectors in the zone (Reference to FIG. 2, which illustrates the disk drive commands operating each zone under a lock mode.) so that it is not possible to read and write data in the protect zone 12 so as to perform the protect function.

The user can decide the size of each zone via a proper utility such as the disk partition program FDISK or DiskEdit in DOS so as to offer a handier way to perform zone partitioning in the disk drive. The ROM zone 11 and the protect zone 12 provide the same function as the user zone 13 so that all commands can be executed at the ROM zone 11 and the protect zone before being enabled.

After the disk drive 1 being partitioned physically, three registers, R_index 111, P_index 121 and LBA_max, are set up to record the physical location of each zone with the size thereof in the disk drive 1.

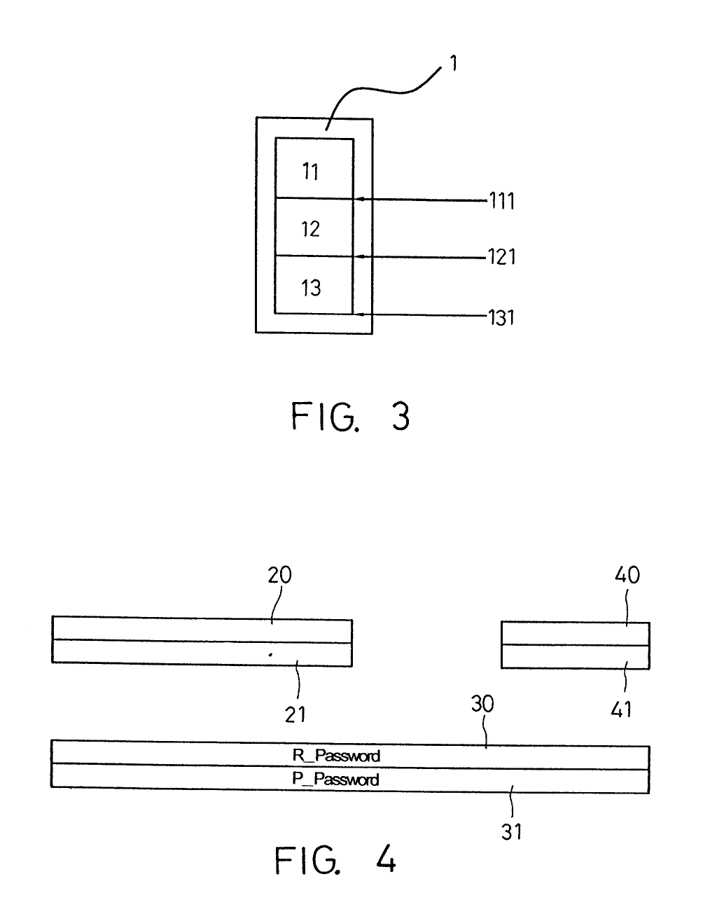

Referring to FIG. 3, the meaning of theses three registers, R_index 111, P_index 121 and LBA_max, are illustrated and these three parameters can be utilized to determine the partitioned disk. The rule for determining the partitioned disk is as follows: (1)When the register R_index≧1 and the register LBA_max>the register P_index>the register R_index, the disk drive 1 is divided into three zones, the user zone 13, the ROM zone 11 and the protect zone 12. (2)When the register R_index≧1 and the register LBA_max=the register P_index>the register R_index, the disk drive 1 is divided into two zones, the user zone and the ROM zone. (3) When the register R_index≧1 and the register LBA_max>the register P_index=the register R_index, the disk drive 1 is divided into two zones, the user zone and the protect zone. (4) when the register R_index≧1 and the register LBA_max=the register P_index=the register R_index, the disk drive is divided into the user zone.Wherein, the three registers, R_index 111, P_index 121 and LBA_max, are assigned a value by way of the utility and, for instance, the utility A can find the length of each zone in a master boot record (MBR) of the disk drive 1 automatically and assign a value to the three registers, R_index 111, P_index 121 and LBA_max respectively after counting.

After being set up and before being assigned a password, the ROM zone 11 and the protect zone 12 can execute all the ATA commands of the disk as the user zone 13 does. At this time, a R_password 30 and a P_password 31 are provided with a default value of 0xFFFFFF initially and the related functions of the ROM zone 11 and the protect zone 12 can start after being enabled by the disk control firmware once the R_password 30 and the P_password 31 are assigned a value different from 0xFFFFFF.

When the power is on or the system is reset with any means and with the disk control firmware having detected the R_password 30 or the R_password 31 being not the default value, the data protect function provided in the ROM zone 11 or in the protect zone 12 starts. However, if the ROM zone does not exist, the P_password 31 is prohibited.

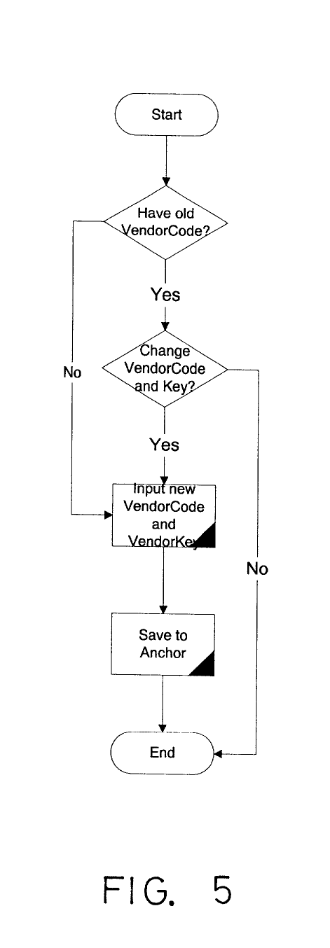

Referring to FIG. 4, various registers in the preferred embodiment are illustrated. It can be seen in FIG. 4 that it shows a register structure related to the password design and the R_password 30 and the P_password 31 can be assigned through an external program.

The system designer owns a control code, which is called a vender code 20 here, and the vender code 20 is an independent control code. A vender key 21 is set up by the system assigner and it is treated a number similar to the batch number. Both of the vender code 20 and the vender key 20 are input by way of an independent external application program such as a utility B. Key numbers 40, 41 is assigned by the system user through the utility A. The key numbers 40, 41 have 8 bites respectively with 7 bites thereof being effective and are defined that the nth password in 128 passwords is effective. Because any password has a size of 4 bytes, 512 bytes of passwords have to be recognized during each check for the passwords. The flow chart shown in FIG. 5 illustrates the process for setting up the vender code 20 and the vender key 21.

It means the function of the ROM zone 11 or the protect zone is in a state of starting or locking as soon as the R_password 30 and P_password are assigned. In case of the ROM zone 11 or the protect zone 12 being unlocked, it is necessary to perform a check and an unlock procedure via special disk command. If the check for passwords is failed, the functions of the ROM zone 11 and the protect zone 12 start immediately. The disk commands for detecting the password are defined in Table 1 and the table 1 includes ATA command codes specially defined in the present invention, description of input rules, description of error response and instruction for commands.

TABLE 1
ATA commands for password detection.

Command code-FEh
Input-

| Address | ATA | Default |
|---|---|---|
| 0x1f7 | Command | 0xFE |
| 0x1f6 | Dry/Head | — |
| 0x1f5 | CylMSB | — |
| 0x1f4 | CylLSB | — |
| 0x1f3 | SecNum | — |
| 0x1f2 | SecCnt | 0xFE |
| 0x1f1 | Feature Cmd | 0xAA/0xBB |

0xAA: indicating detection of R_password 30
0xBB: indicating detection of P_password 31

Error response output-the component part may respond to ABRT of the error register if the command is not supported, and data is in the ROM zone 11 or in the protect zone 12.

| Status register | | | | Error register | | | |
|---|---|---|---|---|---|---|---|
| RDY | DWF | CORR | ERR | UNC | IDNF | ABRT | AMNF |
| X | X | | X | | | X | |

Description of commands—the command may request a disk sector of data to be sent from the host and the function of commands can be controlled by way of the data.

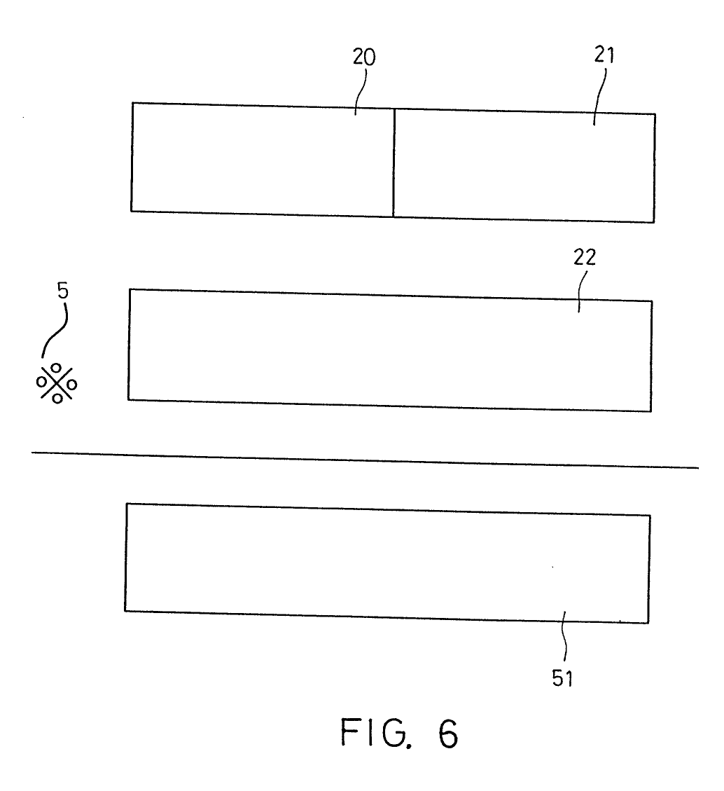

Referring to FIG. 6, the firmware corresponding to the operation mode of password in the preferred embodiment of the present invention is illustrated. As soon as the firmware has obtained an effective password 22 designated by the key numbers 40, 41 among 128 passwords, a calculation process shown in FIG. 6 is performed such that the function of the ROM zone 11 or the protect zone 12 is unlocked in case of calculated result being the same as the R_password 30 or the P_password 31. That is, the read only function of the ROM zone 11 or the protect function of the protect zone is disabled so that the ROM zone 11 or the protect zone can be read or written data as the user zone does.

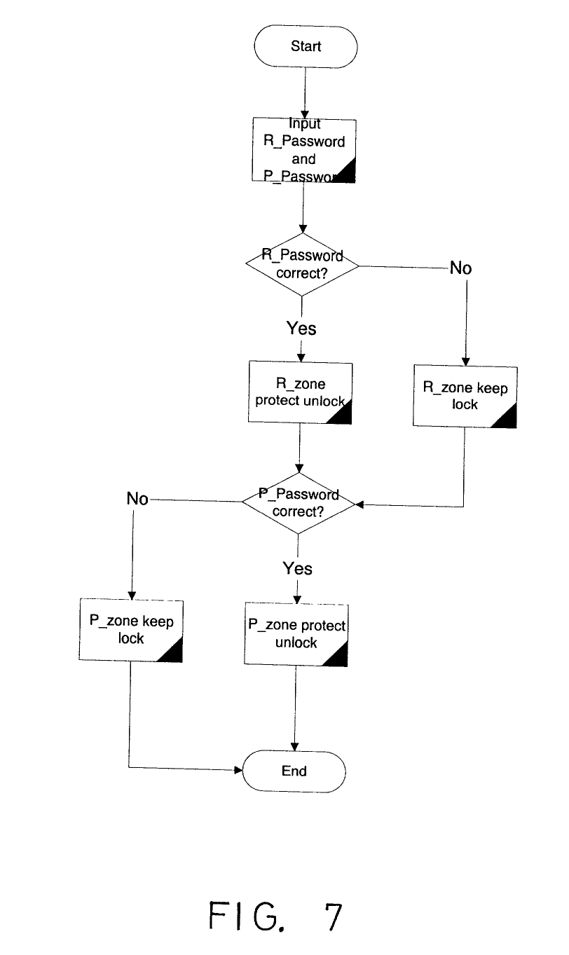

Referring to FIG. 7, a flow chart of unlocking function of the ROM zone and the protect zone in the preferred embodiment of the present invention is illustrated.

It is appreciated from the foregoing, the frequently used system record can be saved in the user zone 13 and the main system program or the drive program can be saved in the ROM zone 11 to avoid that the programs are subjected to abnormal or not allowed change and revision so as not to damage the operation of the system. The core program of the system can be saved in the protect zone 12 and the password has to be confirmed before the core program can be executed. Therefore, the present invention can give the disk system an effective function of protect with lock to protect the intellectual property for the system designer and to protect the data in secret for the user reliably. These advantages are not possible for all conventional types of disk drives to reach effectively.

While the invention has been described with reference to a preferred embodiment thereof, it is to be understood that modifications or variations may be easily made without departing from the spirit of this invention, which is defined in the appended claims.

What is claimed is:

1. A method for data security with lock in a hard disk and a solid state disk, comprising following steps:
a procedure for partitioning a disk drive into a plurality of disk zones;
offering a plurality of registers for indicating a record of a size of the respective partitioned disk zone; and
offering a procedure of mathematical operation for treating a user input data and a register data.

2. The method for data security with lock in a hard disk and a solid state disk according to claim 1, wherein the registers are a R_index register, a P_index register and a LBA_manupper register for indicating records of three disk zone sizes.

3. The method for data security with lock in a hard disk and a solid state disk according to claim 1, wherein the said disk zones are assigned as a user zone, a ROM zone and a protect zone.

4. The method for data security with lock in a hard disk and a solid state disk according to claim 2, wherein when the register R_index≧1 and the register LBA_max>the register P_index>the register R_index, the disk drive 1 is divided into three zones, the disk drive is divided into the user zone, the ROM zone and the protect zone.

5. The method for data security with lock in a hard disk and a solid state disk according to claim 2, wherein when the register R_index≧1 and the register LBA_max=the register P_index>the register R_index, the disk drive is divided into two zones, the user zone and the ROM zone.

6. The method for data security with lock in a hard disk and a solid state disk according to claim 2, wherein when the register R_index≧1 and the register LBA_max>the register P_index=the register R_index, the disk drive 1 is divided into two zones, the user zone and the protect zone.

7. The method for data security with lock in a hard disk and a solid disk according to claim 2, wherein when the register R_index≧1 and the register LBA_max=the register P_index=the register R_index, the disk drive is divided into the user zone.

8. The method for data security with lock in a hard disk and a solid state disk according to claim 1, wherein a password operation mode is by way of a mathematical operation with the user input data and the register data.
